(19) United States
(12) Patent Application Publication
(10) Pub. No.: US 2017/0067812 A1
(43) Pub. Date: Mar. 9, 2017

(54) SEPARATION SAMPLING MODULES FOR USE WITHIN A BUCKET OF A CENTRIFUGE

(71) Applicant: The Research Foundation for the State University of New York, Albany, NY (US)

(72) Inventors: Tony P. HOANG, Albany, NY (US); Kenneth A. HALVORSEN, Glenmont, NY (US)

(73) Assignee: The Research Foundation for the State University of New York, Albany, NY (US)

(21) Appl. No.: 15/356,023

(22) Filed: Nov. 18, 2016

Related U.S. Application Data
(63) Continuation-in-part of application No. 14/927,026, filed on Oct. 29, 2015.
(60) Provisional application No. 62/073,783, filed on Oct. 31, 2014.

(51) Int. Cl. G01N 15/04; G01N 21/85; B04B 15/00; B01D 21/26; B01D 21/30; G01N 21/59; B04B 13/00

(52) U.S. Cl. CPC G01N 15/042; G01N 21/59; G01N 21/85; B04B 13/00; B01D 21/262; B01D 21/302; B04B 15/00; G01N 2015/047

(57) ABSTRACT

A separation sampling module for use within a bucket of a centrifuge for monitoring separation of a sample in a container includes a housing operable for supporting the container for containing the sample and removably positionable within the bucket of the centrifuge, at least one light source for illuminating the sample, at least one light detector for detecting light from the sample, an accelerometer for measuring acceleration of the housing, and at least one of a power source and a connector operably connectable to a power source for use in powering the at least one light source. Light from the at least one light source passing through the sample defines a light path disposed in a direction across the direction of a centrifugal force when the separation sampling module is disposed in the bucket and rotated in the centrifuge.

### CLAIM TO PRIORITY

This application is a continuation-in-part of U.S. patent application Ser. No. 14/927,026, filed Oct. 29, 2015, entitled “Electrical Systems, And Separation Sampling Modules For Use Within A Bucket Of A Centrifuge,” which application claims the benefit of U.S. Provisional Application No. 62/073,783, filed Oct. 31, 2014, entitled “Electrical Systems, And Separation Sampling Modules For Use Within A Bucket Of A Centrifuge”, and which applications are hereby incorporated in their entirety herein by reference.

### FIELD OF THE DISCLOSURE

This disclosure relates to separation devices, and more particularly to separation sampling modules for use within a bucket of a centrifuge.

### BACKGROUND

A centrifuge is a type of research equipment that spins a liquid suspension at high rotation rates to separate it into distinct layers based on density. Typical liquid suspensions that may be separated include blood, water, and crude oil.

### SUMMARY

In a first aspect, the present disclosure provides a method for electrically grounding an electronic device disposed in a housing and a generally surrounding metal structure. The method includes positioning the electronic device disposed in the housing in the generally surrounding metal structure, electrically connecting the electronic device with an inside portion of the generally surrounding metal structure.

In a second aspect, the present disclosure provides a method for wirelessly transmitting data from an electronic device disposed in a housing from a generally surrounding metal structure. The method includes positioning the electronic device comprising a transmitter disposed in a housing in the generally surrounding metal structure, and electrically connecting the electronic device with an inside portion of the generally surrounding metal structure so that the surrounding metal structure acts as an antenna.

In a third aspect, the present disclosure provides the above methods wherein the generally surrounding metal structure is disposed in a generally surrounding electrically grounded second electronic device.

In a fourth aspect, the present disclosure provides the above methods in which the electrically connecting comprises automatically electrically connecting the electronic device with the inside portion of the generally surrounding metal structure when positioning the electronic device disposed in the housing in the generally surrounding metal structure.

In a fifth aspect, the present disclosure provides an electrical system which includes a first housing portion, a first portion of an electrical device disposed in the first housing, a second housing portion releasably attachable to the first housing portion, and a second portion of the electrical device disposed in the second housing portion. The first portion of the electrical device is electrically releasably connectable to the second portion of the electrical device when the first housing portion is releasably connectable to the second housing portion.

In a sixth aspect, the present disclosure provides a separation sampling module for use within a bucket of a centrifuge for monitoring separation of a sample in a container. The separation sampling module includes a housing operable for supporting the container for containing the sample and removably positionable within the bucket of the centrifuge, at least one light source for illuminating the sample, at least one light detector for detecting light from the sample, and at least one of a power source and a connector operably connectable to a power source for use in powering the at least one light source. Light from the at least one light source passing through the sample defines a light path disposed in a direction across the direction of a centrifugal force when the separation sampling module is disposed in the bucket and rotated in the centrifuge.

In a seventh aspect, the present disclosure provides a method for separating a sample disposed in a container. The method includes rotating the container containing the sample about an axis to apply a centrifugal force on the sample with the centrifugal force defining a rotating radial direction, projecting light onto the rotating sample, and detecting light emitted from the rotating sample. The projected light through the sample defines a light path disposed in a direction across the direction of the centrifugal force when the separation sampling module is rotated.

In eighth aspect, the present disclosure provides separation sampling module for use within a bucket of a centrifuge for monitoring separation of a sample in a container. The separation sampling module includes, for example, a housing operable for supporting the container for containing the sample and removably positionable within the bucket of the centrifuge, at least one light source for illuminating at least a portion of the sample, at least one light detector for detecting light from the sample, an accelerometer for measuring acceleration of the housing, and at least one of a power source and a connector operably connectable to a power source for use in powering the at least one light source. Light from the at least one light source passing through the sample defines a light path disposed in a direction across the direction of a centrifugal force when the separation sampling module is disposed in the bucket and rotated in the centrifuge.

In a ninth aspect, the present disclosure provides a method for separating a sample disposed in a container. The method includes, for example, rotating the container containing the sample about an axis to apply a centrifugal force on the sample, the centrifugal force defining a rotating radial direction, detecting acceleration of the rotating container, and projecting light onto the rotating sample, and detecting light emitted from the rotating sample. The projected light through the sample defines a light path disposed in a direction across the direction of the centrifugal force when the separation sampling module is rotated.

Additional features and advantages are realized through the concepts of the present disclosure. Other embodiments and aspects of the disclosure are described in detail herein and are considered a part of the claims.

### BRIEF DESCRIPTION OF THE DRAWINGS

Various aspects of the present disclosure are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 is a perspective view of an embodiment of a centrifuge force microscope module and an embodiment of a counterweight module in accordance with aspects of the present disclosure disposed in a centrifuge;

FIG. 2 is an enlarged perspective view of the centrifuge force microscope module of FIG. 1 having an electronics module and an optical module;

FIG. 3 is an enlarged perspective view of the counterweight module of FIG. 1 having a plurality of holders and weights;

FIG. 4 is a block diagram of a centrifuge force microscope system employing the centrifuge force microscope module and a counterweight module of FIG. 1;

FIG. 5 is an enlarged perspective view of the centrifuge force microscope module of FIG. 2 removed from the bucket;

FIG. 6 is a perspective view of the lower housing of the electronics module of the centrifuge force microscope module of FIG. 5;

FIG. 7 is a perspective view of another embodiment of a lower housing of the electronics module of a centrifuge force microscope module in accordance with aspects of the present disclosure;

FIG. 8 is a front perspective view of the upper housing of the electronics module and the optical module of the centrifuge force microscope module of FIG. 5;

FIG. 9 is a rear perspective view of the upper housing of the electronics module and the optical module of the centrifuge force microscope module of FIG. 5;

FIG. 10 is a right side perspective view of the upper housing of the electronics module of the centrifuge force microscope module of FIG. 5;

FIG. 11 is a top view of the upper housing of the electronics module of the centrifuge force microscope module of FIG. 5;

FIG. 12 is a bottom view of the upper housing of the electronics module of the centrifuge force microscope module of FIG. 5;

FIG. 13 is an elevational view of the optical module of the centrifuge force microscope module of FIG. 5;

FIG. 14 is an enlarged, exploded elevational view of the optical module of FIG. 13;

FIG. 15 diagrammatically illustrates the electrical system of the electronics module of the force microscope module of FIG. 5;

FIG. 16 is an exploded perspective view of the counterweight module of FIG. 3;

FIG. 17 is a perspective view of an embodiment of a counterweight holder in accordance with aspects of the present disclosure for a counterweight module;

FIG. 18 is a flowchart of one embodiment of a method for operating the centrifuge force microscope module of FIG. 1 in accordance with aspects of the present disclosure;

FIG. 19 is a flowchart of one embodiment of a method for analyzing data obtained in connection with operation of the centrifuge force microscope module of FIG. 1 in accordance with aspects of the present disclosure;

FIG. 20 is a diagrammatic illustration of a separation sampling system in accordance with aspects of the present disclosure;

FIG. 21 is a diagrammatic illustration of separation sampling module of FIG. 20;

FIG. 22 is a diagrammatic illustration of a separation process over a period of time in accordance with aspects of the present disclosure;

FIG. 23 is a graph of sample absorption versus time for the process shown in FIG. 22;

FIG. 24 is a perspective view of an embodiment of a centrifuge force microscope module having a housing with a removable side portion in accordance with aspects of the present disclosure;

FIG. 25 is a front elevational view of the centrifuge force microscope module of FIG. 24 with the removable side portion removed;

FIG. 26 is a rear elevational view of the centrifuge force microscope module of FIG. 24 with the removable side portion removed;

FIG. 27 is a diagrammatic illustration of a separation sampling system in accordance with aspects of the present disclosure;

FIG. 28 is a diagrammatic illustration of separation sampling module of FIG. 27;

FIG. 29 is a diagrammatic illustration of a separation process of the detected light intensity over a period of time employing the separation sampling system of FIGS. 27 and 28; and

FIG. 30 is a flowchart of a method for separating a sample disposed in a container in accordance with aspects of the present disclosure.

### DETAILED DESCRIPTION

The ability to quantify interactions between biomolecules is of great interest for scientific and medical research, as well as for drug development. Examples of measurable characteristics of a biomolecular interaction include the affinity (e.g., how strongly the molecules bind/interact) and the kinetics (e.g., rates at which the association and dissociation of molecules occur) of the interaction. Traditionally, such characteristics are measured in solution, using methods such as calorimetry, stop-flow imaging, or surface plasmon resonance. These bulk measurements are limited in many ways, including 1) they report only average behavior and thus may lose important details associated with metastable states and rare events, and 2) they measure chemistry in the absence of externally applied mechanical stress, which can be dramatically different from crowded and dynamic environments in living systems.

In spinning force systems, a motion of a particle (e.g., displacement caused by molecular folding, unfolding or rupture of a bond) can be observed by video tracking methods (e.g., by taking successive images of the particle at a high temporal resolution). In spinning force systems, a light source, a sample and an objective rotate together at the same angular velocity w, these three components appear stationary to each other in a rotating reference frame. Therefore, images of the particle can be formed using traditional imaging techniques, including transmitted- or reflected-light techniques and fluorescence techniques.

### Centrifuge Force Microscope (CFM) System

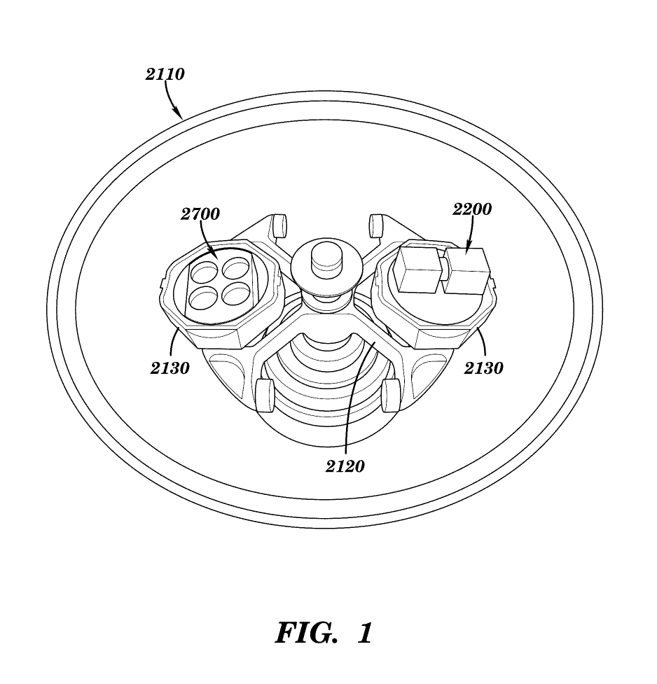

With reference to FIG. 1, a first electronic device such as a centrifuge force microscope (CFM) module 2200 and a CFM counterweight module 2700 in accordance with aspects of the present disclosure may be used in a conventional laboratory centrifuge 2110, such as a second electronic device or a bench top centrifuge with a metal swing bucket rotor 2120, to provide rotational force for the study of molecular interactions, as well as monitoring cells or microparticles. For example, CFM module 2200 and counterweight module 2700 may be disposed in respective buckets 2130 and disposed opposite from each other. FIG. 1 illustrates the CFM) module and CFM counterweight module with the centrifuge at rest. When the centrifuge is operated the bottoms of the buckets rotate outwardly. A suitable centrifuge may be a Sorvall X1 R centrifuge with the TX-400 swinging bucket rotor, where the buckets have an inner diameter of 80 mm.

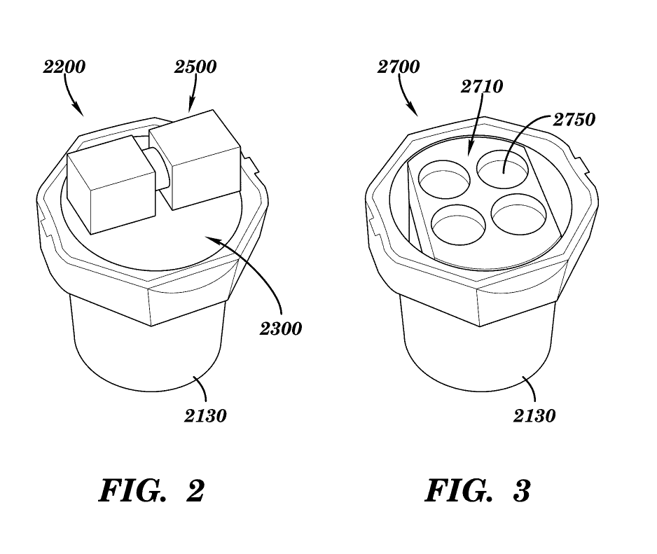

As shown in FIG. 2, CFM module 2200 may include, among other aspects, an electronics module 2300 and an optical module 2500 that fits within bucket 2130. At least some of the outer surface portions of the electronics module may be configured to the contour and provide a snug fit with at least some of the inner surface portions of the conventional bucket. CFM module 2200 may provide a compact design of the various optical and electrical components which components may be easily and readily accessed, assembled, and disassembled by a user in the study of molecular interactions. It will be appreciated that a CFM module may include differently sized rings to enable the CFM module to fit other size centrifuge buckets.

As shown in FIG. 3, CFM counterweight module 2700 may include one or more holders 2710 and one or more weights 2750. At least some of the outer surface portions of the holders may be configured to the contour of at least some of the inner surface portions of the bucket. As described in greater detail below, the counterweight module may be designed to allow a user to assemble and readily match the mass and center of mass of the counterweight module with that of the CFM module.

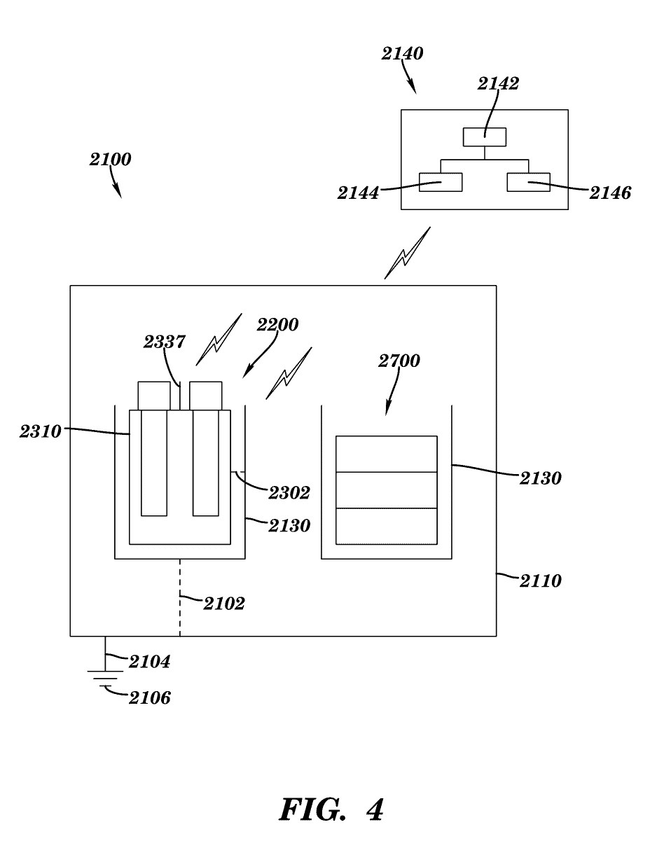

With reference to FIG. 4, a centrifuge force microscope system 2100 in accordance with aspects of the present disclosure may include CFM module 2200, counterweight module 2700, centrifuge 2110, and a computing unit 2140. In an aspect of the present disclosure, as described in greater detail below, electronics module or CFM module 2200 may be operably electrically grounded via an electrical pathway 2302 to bucket 2130, and bucket 2130 through an electrical pathway 2102 to centrifuge 2110, and centrifuge 2110 through an electrical pathway 2104 to a ground 2106. In another aspect of the present disclosure, as described in greater detail below, CFM module 2200 further may comprise a transmitter or transceiver (not shown in FIG. 4), and operably electrically connected to an antenna 2337 for wireless communication with computing unit 2140, and/or operably electrically connected via electrical pathway 2302 to bucket 2130 which bucket may act as an antenna for wireless communication with computing unit 2140, and/or operably electrically connected via electrical pathway 2302 to bucket 2130 and electrical pathway 2102 to centrifuge 2110 which bucket and/or centrifuge may act as an antenna for wireless communication with computing unit 2140. The electrical circuits of the CFM module 2200 may be connected to ground (e.g., earth) via the buckets and centrifuge for several reasons such as to prevent user contact with dangerous voltage if electrical insulation fails, and to limit the build-up of static electricity. When employing the bucket and/or the centrifuges as a transmitting or receiving antenna, the ground to earth may be necessary for the antenna to operate efficiently.

Computing unit 2140 may be any type of computing unit having a processor 2142, a memory 2144 and input/output devices 2146. For example, the computing unit may be a personal computer operating a WINDOWS operating system or Apple OSX operating system, a Unix system, or a tablet computer or smart phone, and configured to communicate such as wirelessly with CFM module 2200.

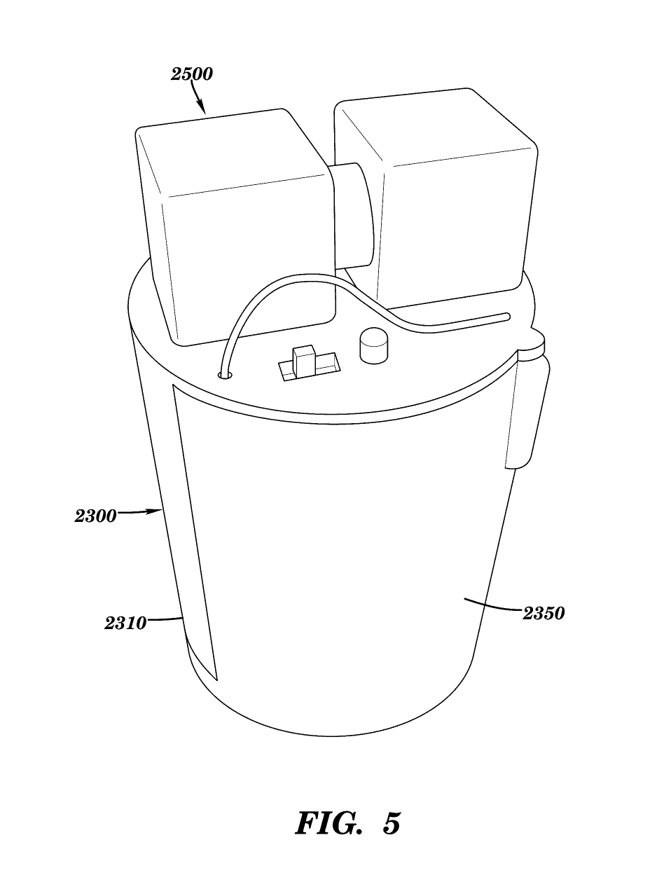

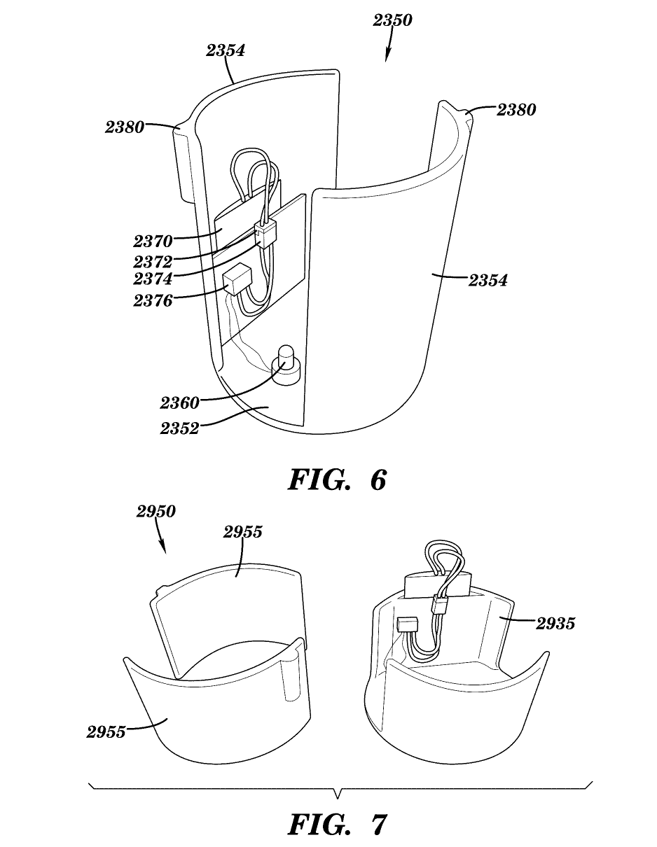

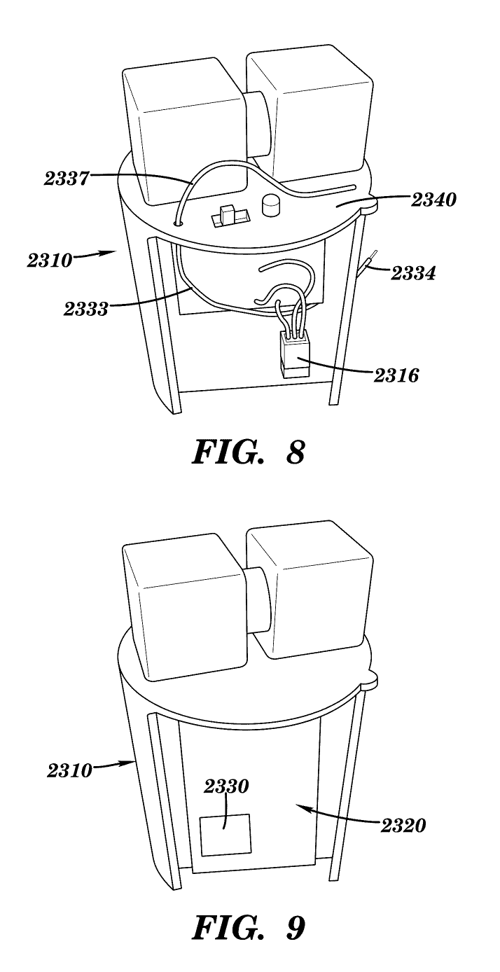

As shown in FIG. 5, electronics module 2300 may include an upper housing 2310 and a lower housing 2350. Electronics module 2300 functions as a support structure for optical assembly module 2500. In addition, electronics module 2300 may also function as a support structure and accommodate various other components. For example, as shown in FIG. 6, lower housing 2350 may include a base 2352 and upwardly extending sides 2354. Lower housing may include a light source 2360 such as a light emitting diode that faces upwardly for illuminating the sample as disclosed below. Lower housing 2350 may also include a cavity for receiving a power source 2370. For example, the power source may be a battery such as 3.3 volt lithium polymer battery. Power source 2370 may include a plug 2372 that plugs into a connector 2374 on lower housing 2350. It will be appreciated that instead of a battery, other alternative power sources may be employed. For example, power may be supplied from an ultracapacitor or a fuel cell. The lower housing of the CFM module may be readily removable allowing easy and ready removal of a discharged battery such as after conducting one or more sample experiments and readily replaced with a fully charged battery for further experiments. Connector 2374 may be connectable to a connector 2376 which is connectable to the upper housing, and when connected operable to power light source 2360. The battery may be wired to step up converter(s) that output 5 volts so that the battery is operable to, for example, supply power to the light source in the lower housing, and as described further below, supply power to a detector such as a camera in the optical assembly module, and a single board computer in the upper housing. The upper and lower housings may releasably interlock together, as well as forming a releaseable electrical connection between the upper and lower housing via electrical connector 2376 and electrical connector 2316 (FIG. 8). The upper housing may include outwardly extending tabs 2380 which are receivable in corresponding cavities in the bucket for fixedly restraining and inhibiting rotation of the housing in the bucket. The spaced apart side of the lower housing may allow for access to the sample as described below. As shown in FIG. 7, a lower housing 2950 may further include a separable base 2935 and a pair of side portions 2955.

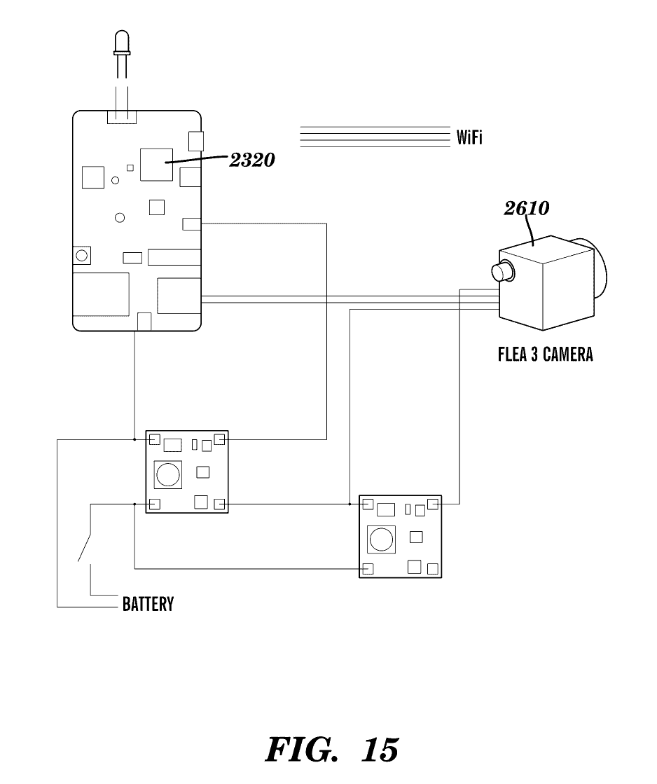

With reference to FIGS. 8 and 9, the upper housing generally includes two parallel flat panels for supporting the electronics in the housing, and which panels are spaced apart to receive the optical assembly module therebetween. Upper housing 2310 may include plug 2316 which is alignable with and electrically connectable with connector 2376 (FIG. 6) when the upper housing is attached to the lower housing. In some embodiments, when the electrical connection is made from the interlocking pieces, the CFM module is turned on. The upper housing may also include a microprocessor or single board computer 2320 (FIG. 15) disposed behind the circuit board 2325 and a WiFi adapter 2330 (FIG. 9). The single board computer may be an Odroid U3 single-board computer. As shown in FIG. 8, a first wire 2333 may be attached at one end to the WiFi adapter and have an exposed end 2334 disposed adjacent to the outer side surface of upper housing 2310. Exposed end 2334 of wire 2333 results in bucket 2130 and/or centrifuge 2110 acting as an antenna for communicating with computing unit 2140 (FIG. 4). It will be appreciated that wire 2333 may be connected to a resilient conducting terminal disposed along the side of the upper housing which resilient conducting terminal may contact the inside surface of the bucket when the CFM module is disposed in the bucket. A wire 2337 disposed above a top surface 2340 of upper housing 2310 may act as an antenna for communicating with computing unit 2140 (FIG. 4). When both wires 2333 and 2337 are employed the bucket and/or centrifuge may act as a primary antenna and wire 2337 may act as a secondary antenna.

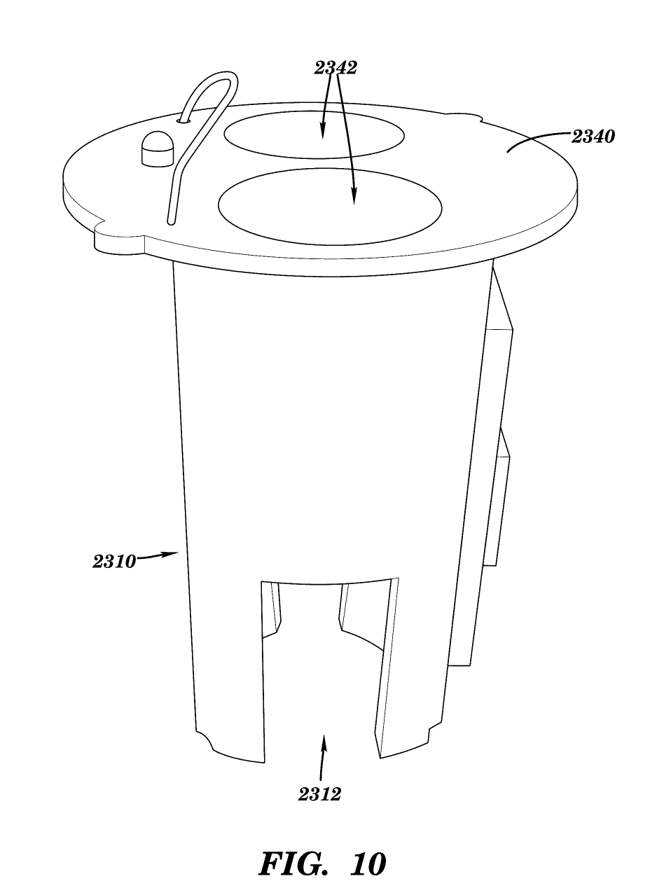

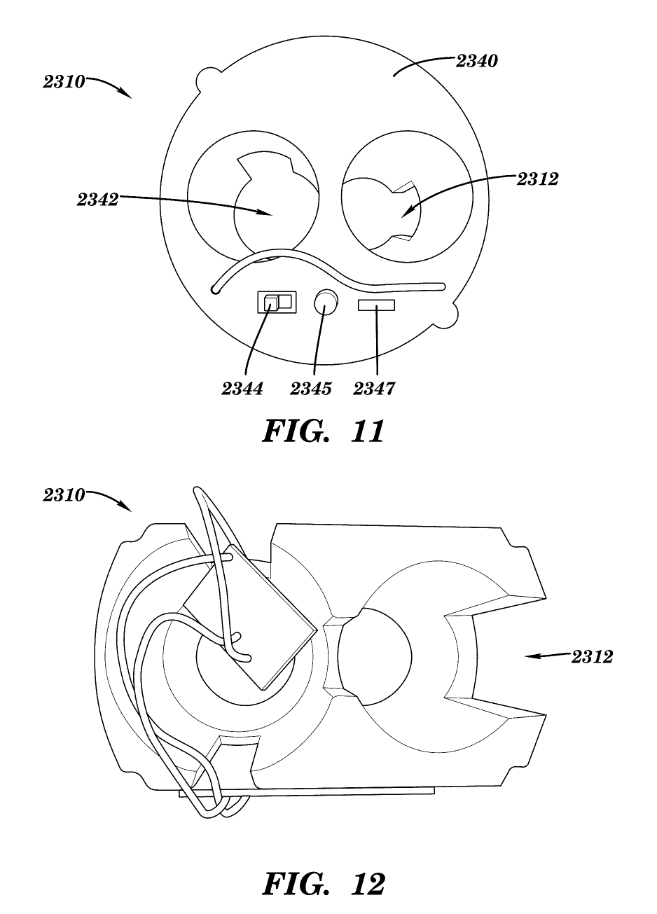

FIGS. 10 and 11 further illustrate upper housing 2310. For example, upper housing 2310 may have top surface 2340 defining a pair of passageways 2342 for receiving the optical module. An on/off button 2344 and a power indicator light 2345 may be located on top surface 2340. The indicator light may be wired to the 5 volt USB connector of the single board computer. A charging port 2347 may be provided on the upper housing to providing a connection wired between the battery and step up converter. Upper housing 2310 may have a side opening 2312 which allows access with a side opening of the optical module for accessing the sample.

With reference to FIG. 12, the upper housing includes an electrical connection for electrically connecting to the detector of the optical assembly module. For example, an electrical connection may be provided for operably connecting the detector such as a camera to the single board computer disposed in the upper housing and allowing 2-way communication therebetween. The single board computer may be additionally connected to a WiFi adapter, allowing communication between the single board computer and computing unit 2140 (FIG. 4). As shown in FIG. 12, a USB MicroB plug breakout board 2349 may be disposed at the lower end of one of upper housing portion 2310 for connecting to a USB port on detector 2610 (FIG. 15). The connection operably carries power to the detector and data signals to the single board computer disposed in the upper housing.

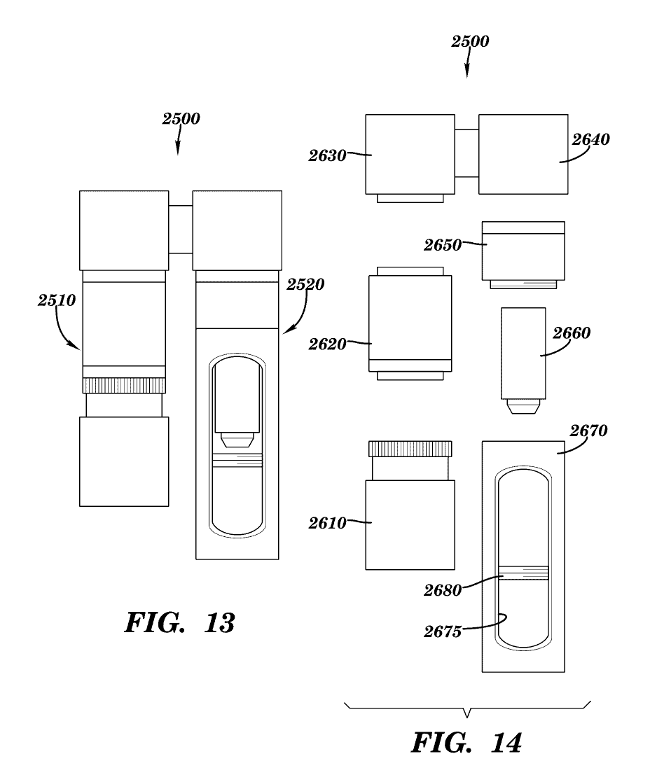

As shown in FIG. 13, optical module 2500 may generally include the major components of a microscope. For example, in this illustrated embodiment, optical module 2500 may include a generally inverted U-shaped optical assembly module comprising a first leg 2510 and a spaced-apart second leg 2520. As best shown in FIG. 14, optical module 2500 may include a detector 2610 such as a digital imager or camera, a tube 2620, a first 45-degree turning mirror 2630, a second 45-degree turning mirror 2640, a tube lens 2650, a lens or an objective 2660, a support 2670, and a sample support 2680. The sample support or sample may be accessible through a side opening 2675 which is alignable by rotating support 2670 with side opening 2312 (FIGS. 10-12) in the upper housing.

The 45-degree turning mirror may be disposed at the base of the legs of the optical module to redirect the light paths to accommodate a longer path length. It will be appreciated from the present description that in other embodiments, the design need not include turning mirrors. The optical module may additionally include illumination components such as diffusers, lenses, and apertures including pinholes, translation stage for focusing the sample, and/or relay lenses. As noted above, support 2670 may be disposed with opening 2675 positioned to the side for access to the sample when the CFM module is assembled. Other embodiments of an optical module may include a light source. For example, a light source may be operably attached to a support below the sample. To house the optics, commercially available lens tubes and components by Thorlabs may be employed. To reduce weight, the housing from the objective lens may be removed, and instead use a custom threaded adapter to mate the objective threads with the standard lens tube threads. An open lens tube for support 2670 may be used so that the sample chamber can be more readily interchanged. In operation of the sampling system, the optical module comprises an optical axis disposed substantially perpendicular to an axis of the centrifuge.

FIG. 15 diagrammatically illustrates the electrical systems of the electronics module which is operably connected to detector 2610 of the optical module. The electrical system may provide two functions, i) to provide power to the electrical components, and ii) to facilitate communication and data transfer (and possibly data processing) from the detector to a storage device or external computer.

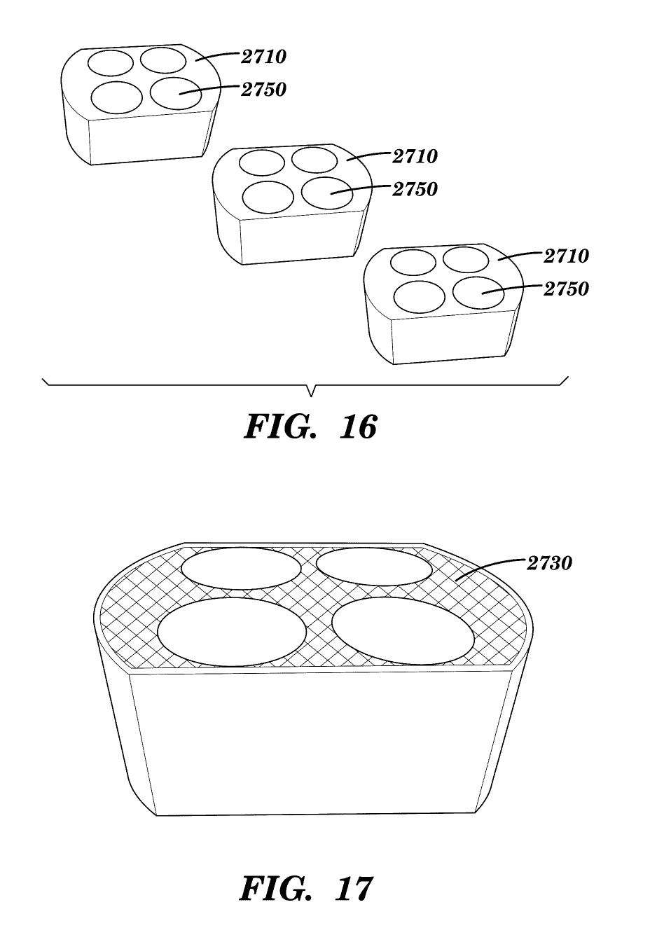

With reference to FIGS. 16 and 17, a counterweight module 2700 may include a plurality of holders 2710 and removable weights 2750. Simply placing the same weight in the opposing bucket that corresponds to the CFM module is not sufficient to counterbalance the system. For example, three holders may be employed and allow an operator to adjustably take into account the weight distribution along the height of the bucket. The design of the holder may employ small stackable weights that are placed in four spaced apart receptacles in each of three vertically stacked housings. The weights may be small metal discs, washers, or coins. For example, an operator can first weigh the CFM module and then determine the correct number of weights to match the CFM module. Next, the operator can distribute the weights within the twelve compartments in the holders to match the center of mass in all three dimensions. It has been observed that distribution of the weights in the vertical dimension (i.e. along the height of the bucket) has a greater effect compared to distribution of the weight laterally or horizontally. Such a counterweight module avoids the likelihood of damaging various components of the CFM module and centrifuge without proper counterbalancing. As shown in FIG. 17, the holder may be fabricated from a plastic material and be generally hollow and having a plurality of reinforcing ribs 2730. From the present description, other counterweight modules may include a holder having one or more weights and one or more mechanical actuators or small motors to move the weight as needed to meet the weight distribution.

In other embodiments, a plurality of the CFM modules may be employed in multiple buckets. In still other embodiments, wireless communication may be provided between at least two CFM modules disposed in two buckets.

The optical module may provide fixed or adjustable dimensions between the various components so that focused images are obtainable. In other embodiments, instead of the detector, imager, or camera being a part of the optical module, the detector, imager, or camera may be part of the electronics module. For example, the detector, imager, or camera may be attached to a lower housing of the electronics module. The various components between the electronics module and the optical module may provide focused images when the electronics module and optical module are assembled. In addition, the components may be adjustable and testable for focusing the images of the sample, for example prior to installing the CFM module in a bucket for testing. While a two piece housing of the electronic module is generally disclosed, it will be appreciated that the housing may include more than two releasably connectable pieces. Data from the CFM module may be wirelessly transmitted from the CFM module or stored in memory, which memory may be removable or downloadable.

In other aspects of the present disclosure, computing unit 2140 (FIG. 4) may act as an interface to set up and control the experiments, and then to retrieve and analyze the data. In the absence of the computing unit or an external computer, the onboard CFM computer 2320 (FIG. 15) or a computer controlling the centrifuge itself could control the system. Operable software may be provided in connection with control of the CFM module and centrifuge, and the transfer and analysis of data resulting from experiments using the CFM module.

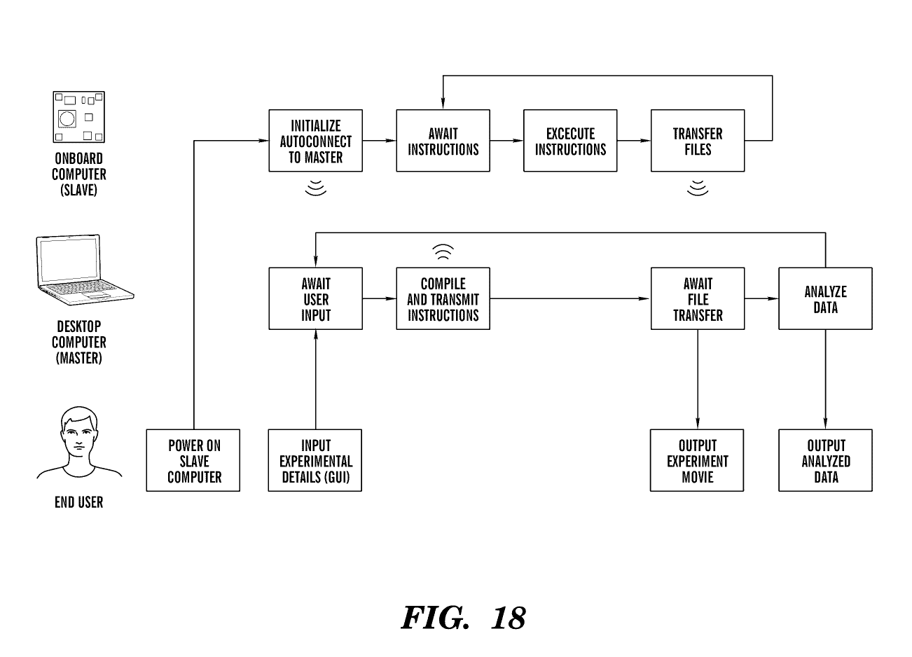

FIG. 18 illustrates an embodiment of a method for operating centrifuge force microscope system 2100 (FIG. 4) in accordance with aspects of the present disclosure. For example, operable software residing on the computing unit 2140 (FIG. 4) such as a desktop computer and onboard processor computer 2320 (FIG. 15) of CFM module 2200 (FIG. 18) may automate the initialization of the CFM module, the collecting of data, and the transfer of data to an external device. When the CFM module is turned on via the on/off switch, power is given to the onboard computer and the boot sequence commences. Through software, the computer automatically generates a WiFi hotspot which can be recognized by any local WiFi connected computer. A command is then run from the external computer to establish a connection, and send relevant experimental instructions to the onboard computer (e.g. number of camera frames to collect, where to store files, frame rate and resolution, etc.) which then executes those instructions and starts the experiment. Upon completion of an experiment, files may be automatically sent by WiFi to the external computer. In other embodiments, the software may automatically perform the start up sequences when the on/off switch is turned to on, and may include booting the onboard computer, powering the camera, powering the light source, running scripts on the onboard computer, communicating with the camera, and communicating with the centrifuge. An indicator light may be wired to provide visual feedback on the status of the equipment including indicating when power is available and indicating when the system is ready to go.

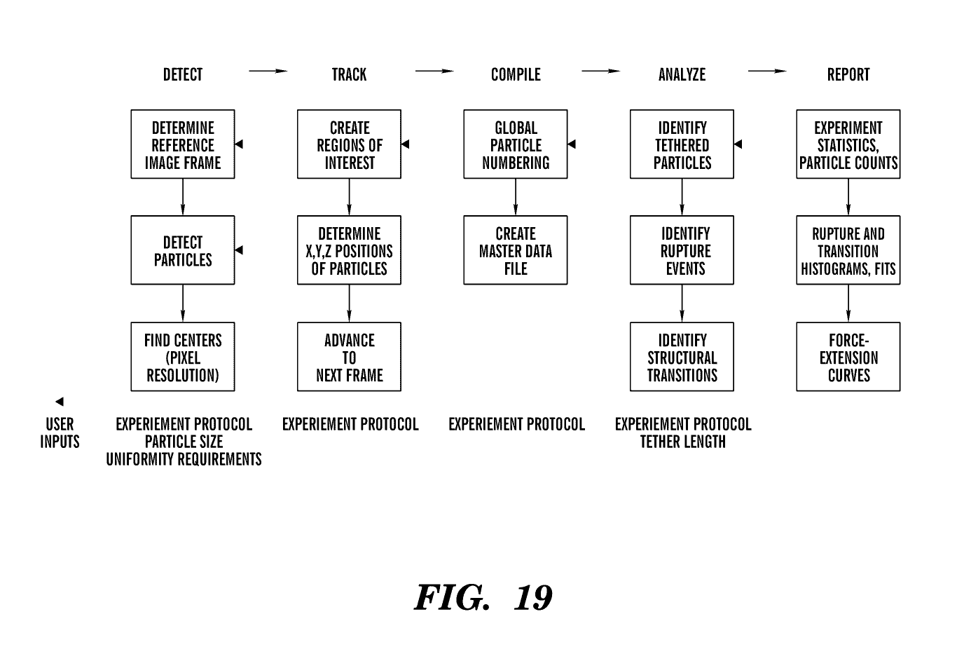

As shown in FIG. 19, analysis of data may include a user observing an image frame at the beginning of the experiment, and providing inputs regarding particles to track. The operable software may be designed to analyze the tracked particles during the experiment.

It may be desirable to have computer control of the centrifuge for a more integrated user experience. Since most centrifuges do not have this feature, one option may be to use an upgraded mainboard from the manufacturer that enables computer control. Another option may be to install a small computer on the inside of the front panel to generate computerized “keypad” signals, overriding the front panel of the instrument and allowing computer control. The computer control of the centrifuge may be interfaced with both the external computer, e.g., computing unit 2140 (FIG. 4) and the onboard processor or computer 2320 (FIG. 15) of the CFM module.

In light of the present description, it will be appreciated that the techniques and aspects of the present disclosure may provide a system that enable user-friendly, high-throughput single molecule experiments using only common bench top centrifuges that exist in laboratories worldwide. Such systems may expand the functionality of centrifugation to provide real-time microscopy of samples as centrifugal forces are applied. The system may allow single-molecule experiments by researchers in single-molecule analysis, as well as by a broad range of non-specialist researchers in other fields.

It will be further appreciated that the techniques and aspects of the present disclosure allow for measuring properties of biomolecules for basic research or drug discovery, with the ability to monitor an individual molecule. Such single molecule experiments may generate information for measuring or screening biomolecular interactions and probing structure of individual molecules such as proteins and nucleic acids. Some of the information from single-molecule experiments cannot be determined from typical ensemble “test tube” measurements, which report only the “average” of the population. The techniques and aspects of the present disclosure may reduce the cost compared to single molecule instruments, allow for a higher throughput by running more than one sample at a time with concurrent data collection, and allow operators to readily and easily maintain the system, conduct the experiments, and analyze the data.

### Separation Sampling Module

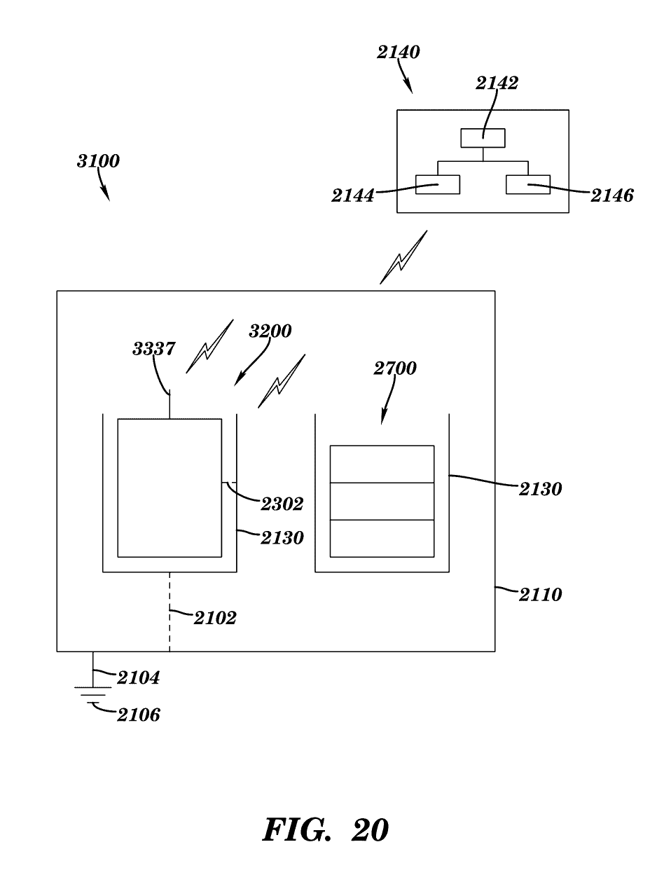

With reference to FIG. 20, a separation sampling system 3100 in accordance with aspects of the present disclosure may include a separation sampling module 3200, counterweight module 2700, centrifuge 2110, and a computing unit 2140. In an aspect of the present disclosure, separation sampling module 3200 may be operably electrically grounded via an electrical pathway 2302 to bucket 2130, and bucket 2130 through an electrical pathway 2102 to centrifuge 2110, and centrifuge 2110 through an electrical pathway 2104 to a ground 2106. In another aspect of the present disclosure, separation sampling module 3200 further may comprise a transmitter or transceiver (not shown in FIG. 20), and operably electrically connected to an antenna 3337 for wireless communication with computing unit 2140, and/or operably electrically connected via electrical pathway 2302 to bucket 2130 which bucket may act as an antenna for wireless communication with computing unit 2140, and/or operably electrically connected via electrical pathway 2302 to bucket 2130 and electrical pathway 2102 to centrifuge 2110 which bucket and/or centrifuge may act as an antenna for wireless communication with computing unit 2140. The electrical circuits of the separation sampling module 3200 may be connected to ground (e.g., earth) via the buckets and centrifuge for several reasons such as to prevent user contact with dangerous voltage if electrical insulation fails, and to limit the build-up of static electricity. When employing the bucket and/or the centrifuges as a transmitting or receiving antenna, the ground to earth may be necessary for the antenna to operate efficiently.

Computing unit 2140 may be any type of computing unit having a processor 2142, a memory 2144 and input/output devices 2146. For example, the computing unit may be a personal computer operating a WINDOWS operating system or Apple OSX operating system, a Unix system, or a tablet computer or smart phone, and configured to communicate such as wirelessly with separation sampling module 3200.

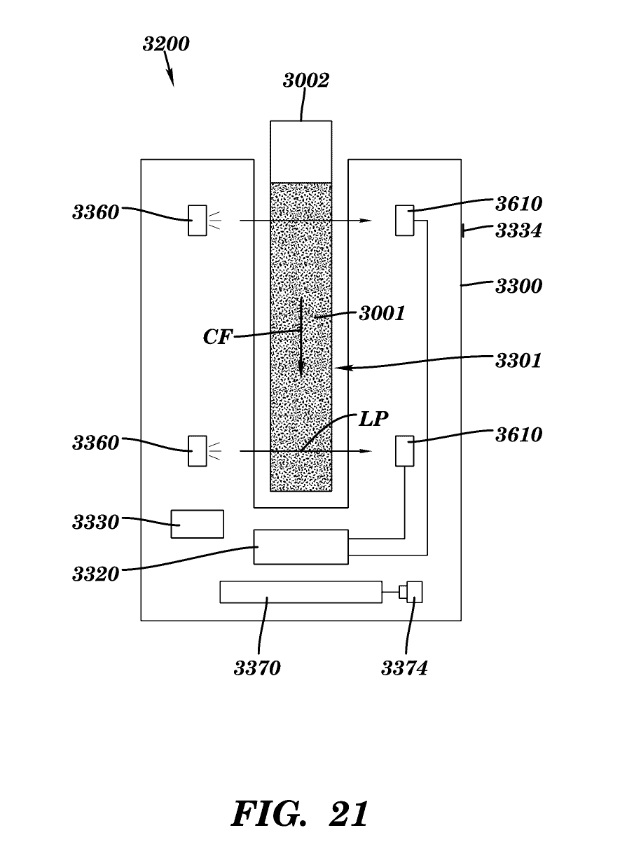

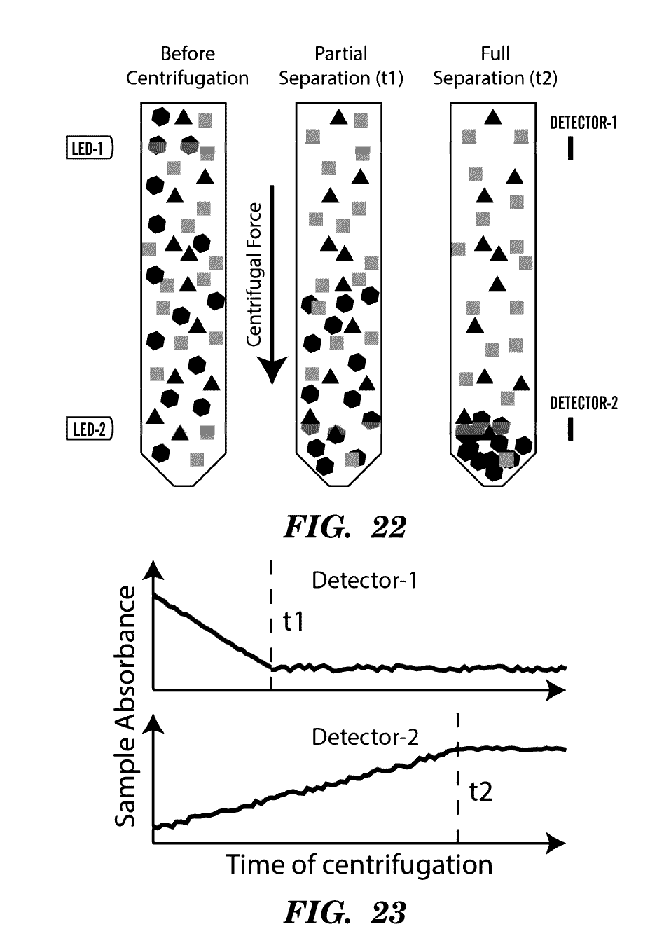

FIG. 21 is a diagrammatic illustration of separation sampling module 3200 for use within a bucket of a centrifuge for monitoring separation of a sample 3001 in a container 3002. Separation sampling module 3200 may include a housing 3300 operable for supporting the container for containing the sample and removably positionable within the bucket of the centrifuge, at least one light source 3360 for illuminating at least a portion of the sample, at least one light detector 3610 for detecting light from the sample, and at least one of a power source 3370 and a connector 3374 operably connectable to a power source. Light through the sample defines a light path LP disposed in a direction across the direction of a centrifugal force CF (FIG. 22) when the separation sampling module is disposed in the bucket and rotated in the centrifuge. As shown in FIG. 21, the container may be an elongated container which defines a longitudinal axis along the length of the container. Light path LP may be generally normal or at 90 degrees to the longitudinal axis of the container. For example, light path LP may be disposed in a direction generally normal or at 90 degrees to a centrifugal force (FIG. 22) when the separation sampling module is disposed in a bucket and rotated in a centrifuge. It will be appreciated that the light path may be disposed at other orientations relative to the longitudinal axis of the elongated container and to the centrifugal force. For example, the light path may be disposed at an angle greater than or less than 90 degrees to the longitudinal axis of the elongated container and to the centrifugal force when the separation sampling module is disposed in a bucket and rotated in a centrifuge.

For example, the light source may be a light emitting diode or a laser, and the detector may be a photodetector or a digital imager. The power source may be a battery such as 3.3 volt lithium polymer battery. It will be appreciated that instead of a battery, other alternative power sources may be employed. For example, power may be supplied from an ultracapacitor or a fuel cell.

Housing 3300 may include a passageway 3301 opening along the top for receiving the container. The passageway may be sized to receive an elongated container such as a standard 15 mL container or a standard 50 mL container.

As shown in FIG. 21, light sources 3360 may be disposed adjacent to one side of container 3002 for illuminating the sample, and light detectors 3610 may be disposed adjacent to a different side of the container. In other embodiments, at least one mirror may be employed for redirecting light into the sample from a light source, such as disposed along the bottom of the housing. In other embodiments, at least one mirror may be employed for redirecting light from the sample to a light detector, such as a light detector disposed along the bottom of the housing.

Separation sampling module 3200 may include a computing unit or processor 3320 disposed in the housing for monitoring the detected light. The computing unit or a separate memory may be disposed in the housing for storing data regarding the detected light such as when the sample is rotated in the housing and the centrifuge.

Separation sampling module 3200 may further include a transmitter and/or a transceiver 3330 disposed in the housing for transmitting data regarding the detected light such as when the sample is rotated in the housing and the centrifuge. In some embodiments, processor 3320 and transmitter 3330 may be operable to send data for at least one of slowing or stopping rotation of the centrifuge and notifying an operator to slow or stop rotation of the centrifuge, and/or notify the operator at certain degrees of separation of the sample.

Housing 3300 may include an electrical contact 3334 for grounding the separation sampling module to a bucket and/or to a centrifuge. Electrical contact 3334 may also electrically connect wireless transmitter 3330 to a bucket and/or a centrifuge so that the bucket and/or the centrifuge act as an antenna for wirelessly communicating with a remote computing unit.

In some embodiments, the plurality of light sources and the plurality of light detectors may be linearly disposed generally parallel to the direction of the centrifugal force. Different ones of some of the plurality of light sources may emit light having different wavelengths. Different ones of some of the plurality of light detectors may be operable to detect light having different wavelengths.

FIG. 22 illustrates separation of different particles in a solution over time in which certain particles migrate toward the bottom of the tube faster than other particles and so that a detector near the bottom of the tube will report increased light absorbance (at a given wavelength possibly corresponding to the color of the separated particles), while a detector near the top of the tube will report decreased light absorbance. The module may employ a single detector and light source near the bottom, or an array (for example, 2-10 light sources and detectors) to generate more detailed information or data. The data may be illustrated, as shown in FIG. 23.

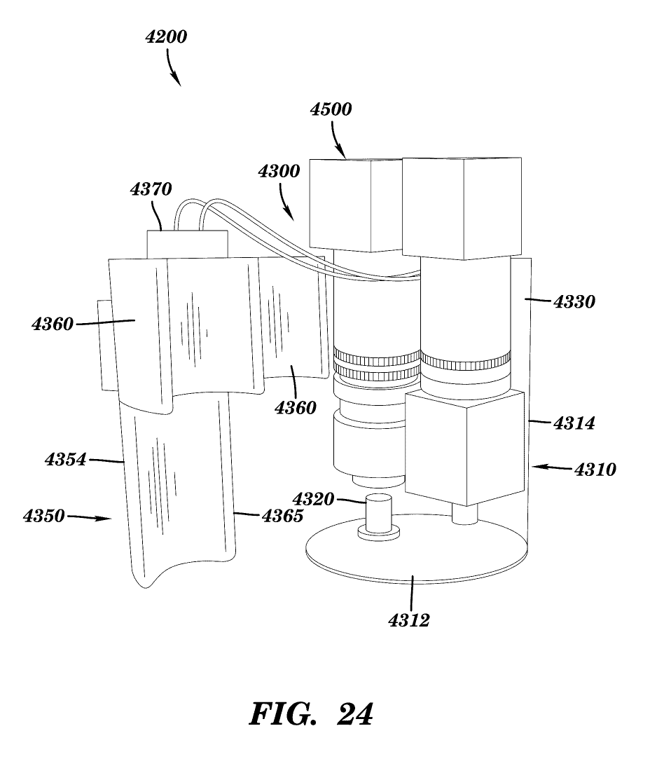

FIG. 24 illustrates an electronic device such as a centrifuge force microscope (CFM) module 4200 in accordance with aspects of the present disclosure that may be used in a conventional laboratory centrifuge, such as a bench top centrifuge with a metal swing bucket rotor to provide rotational force for the study of molecular interactions, as well as monitoring cells or microparticles as similarly discussed in connection with centrifuge force microscope (CFM) module 2200 (FIG. 1). A centrifuge force microscope system in accordance with aspects of the present disclosure may include CFM module 4200, a counterweight module 2700 (FIG. 4), a centrifuge such as centrifuge 2110 (FIG. 4), and a computing unit such as computing unit 2140 (FIG. 4).

CFM module 4200 may include, among other aspects, an electronics module 4300 and an optical module 4500 that together fits within a centrifuge bucket. Optical module 4500 may be essentially the same as optical module 2500 (FIGS. 13 and 14) described above. At least some of the outer surface portions of electronics module 4300 may be configured to the contour and provide a snug fit with at least some of the inner surface portions of a conventional centrifuge bucket. CFM module 4200 may provide a compact design of the various optical and electrical components which components may be easily and readily accessed, assembled, and disassembled by a user in the study of molecular interactions. It will be appreciated that a CFM module may include differently sized rings to enable the CFM module to fit other size centrifuge buckets.

CFM module 4200 may be operably electrically grounded via an electrical pathway to a centrifuge bucket, and the centrifuge bucket through an electrical pathway to a centrifuge, and the centrifuge through an electrical pathway to a ground. In another aspect of the present disclosure, as described in greater detail below, CFM module 4200 may further include a transmitter or a transceiver, and operably electrically connected to an antenna for wireless communication with a computing unit, and/or operably electrically connected via an electrical pathway to a bucket which bucket may act as an antenna for wireless communication with a computing unit, and/or operably electrically connected via an electrical pathway to a bucket and an electrical pathway to a centrifuge which bucket and/or centrifuge may act as an antenna for wireless communication with a computing unit.

As shown in FIG. 24, electronics module 4300 may include a side-by-side housing portions such a first side housing 4310 and a second side housing 4350. Electronics module 4300 functions as a support structure for optical assembly module 4500. In addition, electronics module 4300 may also function as a support structure and accommodate various other components.

For example, first side housing 4310 may include a base 4312, an upwardly extending side 4314, and a light source 4320 such as a light emitting diode that faces upwardly for illuminating a sample in optical module 4500. The upper portion of first side housing 4310 may include inwardly-extending portions 4330 that form cavities for mattingly-engaging and receiving outer portions of optical module 4500.

Second side housing 4350 may include an upwardly extending side 4354. Side 4354 may have an outer curved surface corresponding to the inner curved surface of a centrifuge bucket. The upper portion of second side housing 4350 may include inwardly-extending portions 4360 that form cavities for mattingly-engaging and receiving opposite outer portions of optical module 4500. Second side housing 4350 may also include a cavity for receiving a power source 4370. For example, the power source may be a battery such as 3.3 volt lithium polymer battery. It will be appreciated that instead of a battery, other alternative power sources may be employed. For example, power may be supplied from an ultracapacitor or a fuel cell.

The first side housing and the second side housing may be pivotally attached or releasably interlockable together.

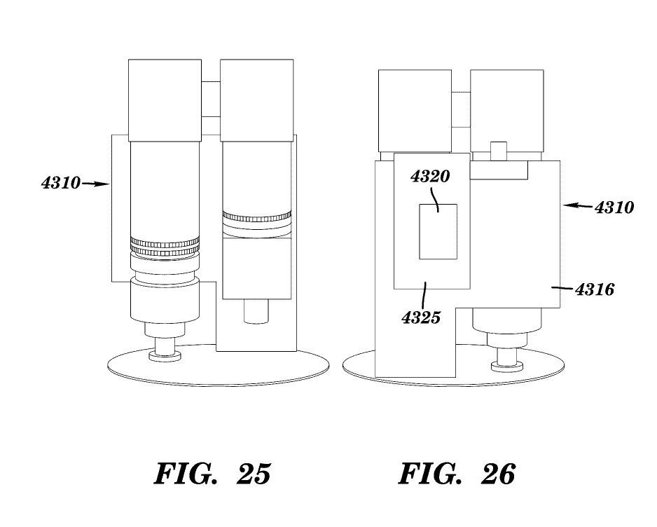

As shown in FIGS. 25 and 26, first side housing 4310 may include a flat panel 4316 (FIG. 26) for supporting electronics in the housing. For example, flat panel 4316 may support a microprocessor or single board computer 4320 (FIG. 26) disposed on a circuit board 4325 (FIG. 26). Other components may include a WiFi adapter. The single board computer may be an Odroid U3 single-board computer. Electronic module 4300 (FIG. 24) may include similar components such as one or more antennas, an on/off button, indicator light, a charging port, an electrical connection for electrically connecting to the detector of the optical assembly module, input/output devises such as found in electronic module 2300 (FIG. 5) described above as well as other components.

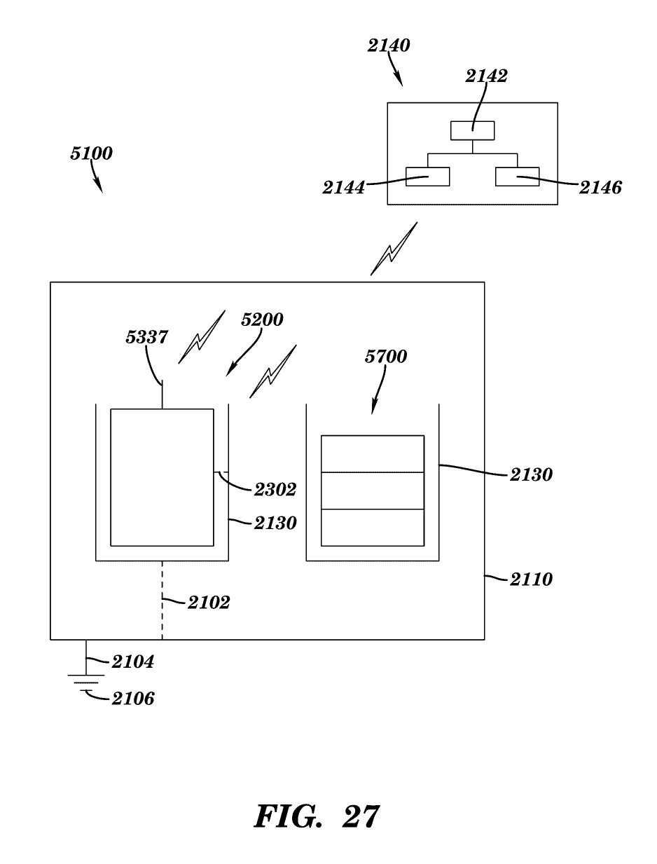

FIG. 27 illustrates a separation sampling system 5100 according to an embodiment of the present disclosure. System 5100 may include a separation sampling module 5200, counterweight module 5700, centrifuge 2110, and a computing unit 2140. In an aspect of the present disclosure, separation sampling module 5200 may be operably electrically grounded via an electrical pathway 2302 to bucket 2130, and bucket 2130 through an electrical pathway 2102 to centrifuge 2110, and centrifuge 2110 through an electrical pathway 2104 to a ground 2106. In another aspect of the present disclosure, separation sampling module 5200 may further may comprise a transmitter or transceiver (not shown in FIG. 27), and operably electrically connected to an antenna 5337 for wireless communication with computing unit 2140, and/or operably electrically connected via electrical pathway 2302 to bucket 2130 which bucket may act as an antenna for wireless communication with computing unit 2140, and/or operably electrically connected via electrical pathway 2302 to bucket 2130 and electrical pathway 2102 to centrifuge 2110 which bucket and/or centrifuge may act as an antenna for wireless communication with computing unit 2140. The electrical circuits of the separation sampling module 5200 may be connected to ground (e.g., earth) via the buckets and centrifuge for several reasons such as to prevent user contact with dangerous voltage if electrical insulation fails, and to limit the build-up of static electricity. When employing the bucket and/or the centrifuges as a transmitting or receiving antenna, the ground to earth may be necessary for the antenna to operate efficiently.

Computing unit 2140 may be any type of computing unit having a processor 2142, a memory 2144, and input/output devices 2146. For example, the computing unit may be a personal computer operating a WINDOWS operating system or Apple OSX operating system, a Unix system, or a tablet computer or smart phone, and configured to communicate such as wirelessly with separation sampling module 5200.

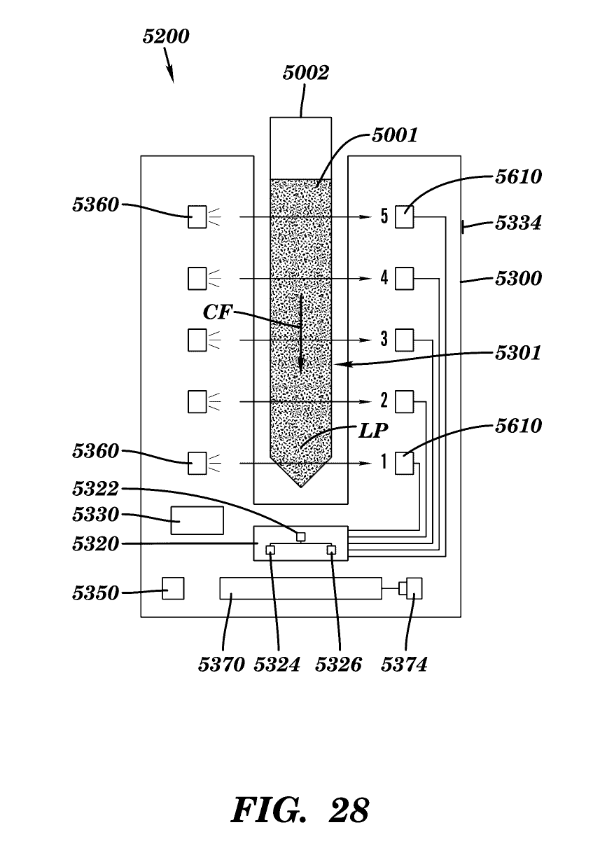

FIG. 28 is a diagrammatic illustration of separation sampling module 5200 for use within a bucket of a centrifuge for monitoring separation of a sample 5001 in a container 5002. Separation sampling module 5200 may include a housing 5300 operable for supporting the container for containing the sample and removably positionable within the bucket of the centrifuge, at least one or a plurality of light sources 5360 for illuminating at least a portion of the sample, at least one or a plurality of light detectors 5610 for detecting light from the sample, an accelerometer 5350, and at least one of a power source 5370 and a connector 5374 operably connectable to a power source. Light through the sample defines a light path LP disposed in a direction across the direction of a centrifugal force CF when the separation sampling module is disposed in the bucket and rotated in the centrifuge.

As shown in FIG. 28, the container may be an elongated container which defines a longitudinal axis along the length of the container. Light path LP may be generally normal or at 90 degrees to the longitudinal axis of the container. For example, light path LP may be disposed in a direction generally normal or at 90 degrees to a centrifugal force CF when the separation sampling module is disposed in a bucket and rotated in a centrifuge. It will be appreciated that the light path may be disposed at other orientations relative to the longitudinal axis of the elongated container and to the centrifugal force. For example, the light path may be disposed at an angle greater than or less than 90 degrees to the longitudinal axis of the elongated container and to the centrifugal force when the separation sampling module is disposed in a bucket and rotated in a centrifuge.

The light source may be a light emitting diode or a laser, and the detector may be a photodetector or a digital imager. The power source may be a battery such as 3.3 volt lithium polymer battery. It will be appreciated that instead of a battery, other alternative power sources may be employed. For example, power may be supplied from an ultracapacitor or a fuel cell.

Housing 5300 may include a passageway 5301 opening along the top for receiving the container. The passageway may be sized to receive an elongated container such as a standard 15 mL container or a standard 50 mL container.

As shown in FIG. 28, light sources 5360 may be disposed adjacent to one side of container 5002 for illuminating the sample, and light detectors 5610 may be disposed adjacent to a different side of the container. In other embodiments, at least one mirror may be employed for redirecting light into the sample from a light source, such as disposed along the bottom of the housing. In other embodiments, at least one mirror may be employed for redirecting light from the sample to a light detector, such as a light detector disposed along the bottom of the housing.

Separation sampling module 5200 may include a computing unit 5320 disposed in the housing for monitoring the detected light. Computing unit 5320 may include a processor 5322, a memory 5324, and input/output devices 5326. The computing unit or a separate memory may be disposed in the housing for storing data regarding the detected light such as when the sample is rotated in the housing and the centrifuge as described below.

Separation sampling module 5200 may further include a transmitter and/or a transceiver 5330 disposed in the housing for transmitting data regarding the detected light such as when the sample is rotated in the housing and the centrifuge. In some embodiments, processor 5320 and transmitter 5330 may be operable to send data for at least one of slowing or stopping rotation of the centrifuge and notifying an operator to slow or stop rotation of the centrifuge, and/or notify the operator at certain degrees of separation of the sample.

Housing 5300 may include an electrical contact 5334 for grounding the separation sampling module to a bucket and/or to a centrifuge. Electrical contact 5334 may also electrically connect wireless transmitter 5330 to a bucket and/or a centrifuge so that the bucket and/or the centrifuge act as an antenna for wirelessly communicating with a remote computing unit.

In some embodiments, the plurality of light sources and the plurality of light detectors may be linearly disposed generally parallel to the direction of the centrifugal force. For example, some of the light sources/detectors may be spaced closer together along the bottom of the sample container, and other of the light sources/detectors may be spaced further apart along the upper portion of the sample container. Different ones of some of the plurality of light sources may emit light having different wavelengths. Different ones of some of the plurality of light detectors may be operable to detect light having different wavelengths.

The separation of different particles in a solution occurs over time in which certain particles migrate toward the bottom of the tube faster than other particles so that a detector near the bottom of the tube may report increased light absorbance (at a given wavelength possibly corresponding to the color of the separated particles), and a detector near the top of the tube will report decreased light absorbance. The module may employ a single detector and light source near the bottom, or an array (for example, 2-10 light sources and detectors) to generate more detailed information or data.

With reference to FIGS. 27 and 28, separation sampling module 5200 may collect light intensity of a sample under centrifugal force in a commercial bench-top centrifuge. The separation sampling module 5200 may include 5 light detectors with companion light sources. The light detectors may be photoresistors or photodetectors, and the light sources may be white LEDs. Although separation sampling module 5200 collects data from the 5 sensors, only data from one detector, for example detector 2, may be employed and analyzed as described below.

For example, analyzing data from detectors 3-5 may be undesirable because the sample may or may not have fully sedimented out of solution from that height. Analysis of the Detector 1 data may show a repeatable artifact resulting from the sample collecting on the test tube's sloped sidewall then sliding off. Detector 2 is the sensor closest to the bottom of the test tube that may be unaffected by the sloped sidewall of the test tube, e.g., Detector 2 is spaced from converging sides of the container.

Separation sampling module 5200 employs accelerometer 5350 (FIG. 28) to determine if the instrument is spinning inside the centrifuge. If the accelerometer is activated, Detectors 1-5 begin collecting light intensity data and may begin to process the data in computing unit 5320 (FIG. 28) or immediately transfer data to remote external computing unit 2140 (FIG. 27). The rate of change of the intensity of the detected light from the sample may be used to determine when separation of the sample may be complete.

With reference to FIG. 28, for example, in separation sampling module 5200, processor 5322 of computing unit 5320 disposed in housing 5300 may be operable for monitoring accelerometer 5350. Processor 5322 may be operable to control projection of light onto the rotating sample based on detection of the acceleration of the rotating container, and control detection of light emitted from the rotating sample based on detection of the acceleration of the rotating container. Processor 5322 may be operable to monitor a rate of change in the intensity of the detected light emitted from the rotating sample. Processor 5322 may be operable to enable stopping rotation of the container based on the rate of change in the intensity of the detected light emitted from the rotating sample. Processor 5322 may be operable to control transmission of data regarding the detected light emitted from the rotating sample to a location remote from the rotating container.

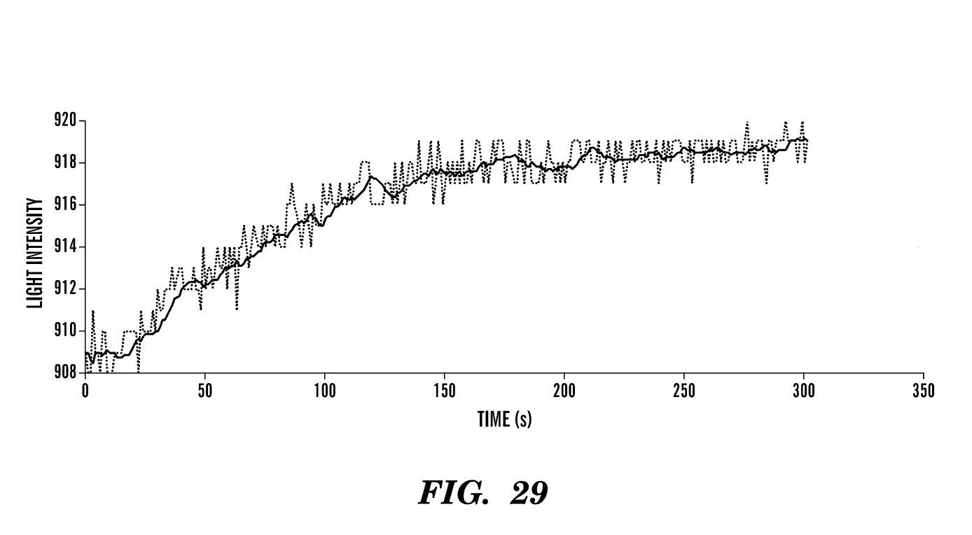

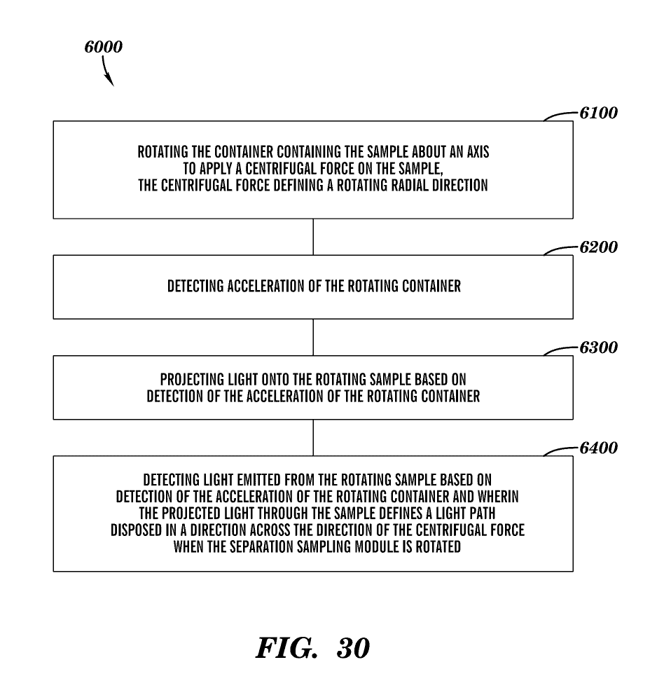

For example, the average of the last 10 light intensity values at one detector may be calculated to create a “running average” or “block average”, as shown as a solid line in FIG. 29. Evaluation of the last 10 values from the “running average” may be used to determine whether the values differ significantly or not. If the values are significantly different (e.g., greater than 10 percent), it means the sample is still sedimenting out of solution and light intensity data continues to be collected. If the values are not significant (e.g., less than 10 percent, less than 5 percent, or other suitable percentage), it means the majority of the sample has sedimented out of solution and a signal may be sent to turn off the light sources and the detection of light to conserve battery power, and/or a signal may be sent to an external computer to shut down the centrifuge, and/or a signal may be sent to the user to notify the user that the experiment is nearing completion.

FIG. 30 illustrates a method 6000 for separating a sample disposed in a container in accordance with an embodiment of the present disclosure. Method 6000 includes at 6100 rotating the container containing the sample about an axis to apply a centrifugal force on the sample, the centrifugal force defining a rotating radial direction, at 6200 detecting acceleration of the rotating container, at 6300 projecting light onto the rotating sample based on detection of the acceleration of the rotating container, and at 6400 detecting light emitted from the rotating sample based on detection of the acceleration of the rotating container. The projected light through the sample defines a light path disposed in a direction across the direction of the centrifugal force when the separation sampling module is rotated.

The projecting light may include projecting light onto the rotating sample based on detection of the acceleration of the rotating container, and the detecting light may include detecting light emitted from the rotating sample based on detection of acceleration of the rotating container. The detecting may include detecting light emitted from the rotating sample spaced from converging sides of the container. The method may include monitoring a rate of change in the intensity of the detected light emitted from the rotating sample, stopping rotation of the container based on the rate of change in the intensity of the detected light emitted from the rotating sample, and or transmitting data regarding the detected light emitted from the rotating sample to a location remote from the rotating container.

From the present description, it will be appreciated that aspects and features of the above described CFM module and electronic module may be incorporated into the various embodiments of the disclosed separation sampling modules herein. For example, aspects of the upper and lower housing portion of the electronic module for the CFM module may be incorporated into various embodiments of the separation sampling module.

A1. A method for electrically grounding an electronic device disposed in a housing and a generally surrounding metal structure, the method comprising: positioning the electronic device disposed in the housing in the generally surrounding metal structure; and electrically connecting the electronic device with an inside portion of the generally surrounding metal structure. A2. The method of claim A1 wherein the generally surrounding metal structure is disposed in a generally surrounding electrically grounded second electronic device. A3. The method of claim A1 wherein the electrically connecting comprises automatically electrically connecting the electronic device with the inside portion of the generally surrounding metal structure when positioning the electronic device disposed in the housing in the generally surrounding metal structure. A4. The method of claim A1 wherein the housing comprises an electrical contact disposed on an outer surface of the housing electrically connectable to the electronic device, and wherein the electrically connecting comprises automatically electrically connecting the electronic device with the inside portion of the generally surrounding metal structure when positioning the electronic device disposed in the housing in the generally surrounding metal structure to electronically engage the electrical contact with the inside portion of the generally surrounding metal structure. A5. The method of claim A1 wherein portions of an outer surface of the housing and an inner portion of the generally surrounding metal structure are configured to generally fixedly retain the electronic device in a fixed position relative to the generally surrounding metal structure. A6. The method of claim A1 wherein the electronic device disposed in the housing further comprises at least one of a power source and a connector operably connectable to a power source disposed on the housing for powering the electronic device. A7. The method of claim A1 wherein the housing comprises a first housing portion and a releasably attachable second housing portion. A8. The method of claim A7 wherein the first housing portion comprises a power source electrically connectable to the electronic device for powering the electronic device. A9. The method of claim A1 further comprising rotating the generally surrounding metal structure with the electronic device in the housing disposed therein. A10. The method of claim A1 wherein the electronic device disposed in the housing comprises a centrifuge force microscope module. A11. The method of claim A1 wherein the surrounding metal structure comprises a bucket of a centrifuge.

B1. A method for wirelessly transmitting data from an electronic device disposed in a housing and a generally surrounding metal structure, the method comprising: positioning the electronic device comprising a transmitter disposed in a housing in the generally surrounding metal structure; and electrically connecting the electronic device with an inside portion of the generally surrounding metal structure so that the surrounding metal structure acts as an antenna. B2. The method of claim B1 wherein the generally surrounding metal structure is disposed in a generally surrounding electrically grounded second electronic device. B3. The method of claim B1 wherein the electrically connecting comprises automatically electrically connecting the electronic device with the inside portion of the generally surrounding metal structure when positioning the electronic device disposed in the housing in the generally surrounding metal structure. B4. The method of claim B1 wherein the housing comprises an electrical contact disposed on an outer surface of the housing electrically connectable to the electronic device, and wherein the electrically connecting comprises automatically electrically connecting the electronic device with the inside portion of the generally surrounding metal structure when positioning the electronic device disposed in the housing in the generally surrounding metal structure to electronically engage the electrical contact with the inside portion of the generally surrounding metal structure. B5. The method of claim B1 wherein portions of an outer surface of the housing and an inner portion of the generally surrounding metal structure are configured to generally fixedly retain the electronic device in a fixed position relative to the generally surrounding metal structure. B6. The method of claim B1 wherein the electronic device disposed in the housing further comprises at least one of a power source and a connector operably connectable to a power source disposed on the housing for powering the electronic device. B7. The method of claim B1 wherein the housing comprises a first housing portion and a releasably attachable second housing portion. B8. The method of claim B7 wherein the first housing portion comprises a power source electrically connectable to the electronic device for powering the electronic device. B9. The method of claim B1 further comprising rotating the generally surrounding metal structure with the electronic device in a housing disposed therein. B10. The method of claim B1 wherein the electronic device disposed in the housing comprises a centrifuge force microscope module. B11. The method of claim B1 wherein the surrounding metal structure comprises a bucket of a centrifuge.

C1. An electrical system comprising: a first housing portion; a first portion of an electrical device disposed in said first housing; a second housing portion releasably attachable to said first housing portion; a second portion of said electrical device disposed in said second housing portion; and wherein said first portion of said electrical device being electrically releasably connectable to said second portion of said electrical device when said first housing portion is releasably connectable to said second housing portion. C2. The electrical system of claim C1 wherein said first portion of an electrical device comprises at least one of a power source and a connector operably connectable to a power source. C3. The electrical system of claim C1 wherein said electronic device is turned on when said first housing portion is releasably connected to said second housing portion. C4. The electrical system of claim C1 wherein at least one of said first housing portion and second housing portion comprises an electrical contact for contacting a metal structure for grounding said electrical device. C5. The electrical system of claim C1 wherein said electronic device comprises a transmitter and/or a receiver, and at least one of said first housing portion and second housing portion comprises an electrical contact for contacting a metal structure so that the structure acts as an antenna. C6. The electrical system of claim C1 wherein first housing portion and said second housing portion are configured to generally retain said electronic device in a fixed position relative to the housing. C7. The electrical system of claim C1 wherein said housing and said electronic device comprises a centrifuge force microscope module. C8. The electrical system of claim C1 wherein said housing and said electronic device comprises a separation sampling module.

It is to be understood that the above description is intended to be illustrative, and not restrictive. For example, the above-described embodiments and/or aspects thereof may be used in combination with each other. In addition, many modifications may be made to adapt a particular situation or material to the teachings of the various embodiments without departing from their scope.

While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

This written description uses examples in the present disclosure, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A separation sampling module for use within a bucket of a centrifuge for monitoring separation of a sample in a container, said separation sampling module comprising:
a housing operable for supporting the container for containing the sample and removably positionable within the bucket of the centrifuge;
at least one light source for illuminating at least a portion of the sample;
at least one light detector for detecting light from the sample;
an accelerometer for measuring acceleration of said housing;
at least one of a power source and a connector operably connectable to a power source for use in powering said at least one light source; and
wherein light from said at least one light source passing through the sample defines a light path disposed in a direction across the direction of a centrifugal force when said separation sampling module is disposed in the bucket and rotated in the centrifuge.

2. The separation sampling module of claim 1 further comprising a processor disposed in said housing for monitoring said accelerometer.

3. The separation sampling module of claim 2 wherein said processor is operable to control projection of light onto the rotating sample based on detection of said acceleration of the rotating container, and control detection of light emitted from the rotating sample based on detection of said acceleration of the rotating container.

4. The separation sampling module of claim 2 wherein said processor is operable to monitor a rate of change in the intensity of the detected light emitted from the rotating sample.

5. The separation sampling module of claim 2 said processor is operable to enable stopping rotation of the container based on the rate of change in the intensity of the detected light emitted from the rotating sample.

6. The separation sampling module of claim 2 wherein said processor is operable to control transmission of data regarding the detected light emitted from the rotating sample to a location remote from the rotating container.

7. The separation sampling module of claim 1 wherein said at least one light detector is spaced away from converging sides of the container.

8. The separation sampling module of claim 1 wherein said at least one light source comprises a plurality of light sources for illuminating a plurality of portions of the sample, and/or said at least one light detector comprises a plurality of light sources for detecting light from the sample.

9. The separation sampling module of claim 8 wherein said plurality of light sources is disposed adjacent to one side of the container for illuminating the sample; and said plurality of light detectors is disposed adjacent to a different side of the container.

10. The separation sampling module of claim 1 wherein said housing is operable to support an elongated container defining a longitudinal axis along a length of the container, and the light path is at 90 degrees to the longitudinal axis of the container.

11. The separation sampling module of claim 10 wherein different ones of some of said plurality of light sources emit light having different wavelengths.

12. The separation sampling module of claim 10 wherein different ones of some of said plurality of detectors being operable to detect light having different wavelengths.

13. The separation sampling module of claim 10 wherein said plurality of light sources and said plurality of light detectors are linearly disposed generally parallel to the direction of the centrifugal force.

14. The separation sampling module of claim 10 wherein said plurality of light sources and said plurality of light detectors are linearly disposed alongside the container.

15. The separation sampling module of claim 1 wherein said housing comprises a passageway for receiving at least one elongated container.

16. The separation sampling module of claim 1 wherein said housing is operable to support a 15 mL and/or 50 mL centrifuge tube.

17. The separation sampling module of claim 1 further comprising a mirror for redirecting light from said light source into said sample and/or a mirror for redirecting light from said sample to said light detector.

18. The separation sampling module of claim 2 further comprising memory disposed in said housing and operably connected to said processor for storing data regarding the monitored detected light.

19. The separation sampling module of claim 2 further comprising a transmitter disposed in said housing and operably connected to said processor for transmitting data regarding the detected light.

20. The separation sampling module of claim 19 wherein said processor and said transmitter are operable to send data for slowing or stopping rotation of the centrifuge and/or notifying an operator to slow or stop rotation of the centrifuge.

21. The separation sampling module of claim 1 further comprising a wireless transmitter disposed in said housing for wirelessly transmitting data regarding the detected light.

22. The separation sampling module of claim 21 wherein said housing comprises an electrical contact for electrically connecting said wireless transmitter to the bucket and/or to the centrifuge so that the bucket and/or the centrifuge act as an antenna.

23. The separation sampling module of claim 1 wherein said housing comprises an electrical contact for grounding said separation sampling module to the bucket and/or the centrifuge.

24. The separation sampling module of claim 1 wherein said light source comprises a laser or a light emitting diode, and said light detector comprises a photodetector or an imager.

25. A method for separating a sample disposed in a container, the method comprising:
rotating the container containing the sample about an axis to apply a centrifugal force on the sample, the centrifugal force defining a rotating radial direction;
detecting acceleration of the rotating container;
projecting light onto the rotating sample;
detecting light emitted from the rotating sample;
wherein the projected light through the sample defines a light path disposed in a direction across the direction of the centrifugal force when the separation sampling module is rotated; and
wherein the projecting light comprises projecting light onto the rotating sample based on detection of the acceleration of the rotating container; or
wherein the detecting light comprises detecting light onto the rotating sample based on detection of acceleration of the rotating container.

26. The method of claim 25 wherein the projecting light comprises projecting light onto the rotating sample based on detection of the acceleration of the rotating container, and the detecting light comprises detecting light emitted from the rotating sample based on detection of acceleration of the rotating container.

27. The method of claim 25 wherein the detecting comprises detecting light emitted from the rotating sample spaced from converging sides of the container.

28. The method of claim 25 further comprising monitoring a rate of change in the intensity of the detected light emitted from the rotating sample.

29. The method of claim 28 further comprising stopping rotation of the container based on the rate of change in the intensity of the detected light emitted from the rotating sample.

30. The method of claim 25 further comprising transmitting data regarding the detected light emitted from the rotating sample to a location remote from the rotating container.

31. The method of claim 25 wherein the projecting light comprises projecting light from a light source disposed adjacent to one side of the rotating container, and the detecting light comprises detecting light emitted from the rotating sample using a detector disposed adjacent to a different side of the rotating container.

32. The method of claim 25 wherein the container comprises an elongated container defining a longitudinal axis along the length of the container, and the light path is at 90 degrees to the longitudinal axis of the container.

33. The method of claim 25 wherein the rotating the container containing the sample comprises rotating the container containing the sample in a bucket of a centrifuge.

34. The method of claim 33 wherein the projecting light comprises projecting light from a light source disposed in the bucket adjacent to the container, and the detecting light comprises detecting light emitted using a detector disposed adjacent to the container in the bucket.

35. The method of claim 34 further comprising wirelessly transmitting data regarding the detected emitted light from the bucket and/or from the centrifuge acting as an antenna.

36. The method of claim 25 wherein the sample comprises a liquid.

37. The method of claim 25 wherein the sample comprises cells and/or bodily fluids.
